(19) United States
(12) Patent Application Publication
(10) Pub. No.: US 2024/0234862 A1
(43) Pub. Date: Jul. 11, 2024

(54) THERMAL EXCHANGE PLATES FOR IMMERSION COOLING BATTERY ARRAY DESIGNS

(71) Applicant: Ford Global Technologies, LLC, Dearborn, MI (US)

(72) Inventors: Liam E. West, Ferndale, MI (US); Nathan Lee, Novi, MI (US); Wen Dai, Northville, MI (US)

(21) Appl. No.: 18/095,666

(22) Filed: Jan. 11, 2023

(51) Int. Cl. H01M 10/6555; H01M 10/613; H01M 10/625; H01M 10/653; H01M 10/6557; H01M 50/209; H01M 50/291; H01M 50/293

(52) U.S. Cl. CPC H01M 10/6555; H01M 10/613; H01M 10/625; H01M 10/653; H01M 10/6557; H01M 50/209; H01M 50/291; H01M 50/293; B60L 50/64; H01M 2220/20

(57) ABSTRACT

This disclosure relates generally to battery packs for electrified vehicles, and in particular relates to thermal exchange plates for immersion cooled battery arrays. In some aspects, the techniques described herein relate to a battery pack, including: a battery array including a plurality of battery cells, wherein the plurality of battery cells includes a first battery cell and a second battery cell; and a thermal exchange plate, wherein the first battery cell is spaced-apart from the second battery cell by the thermal exchange plate, wherein the thermal exchange plate includes a main section and a projection extending outward from the main section, wherein the projection includes a channel configured to communicate a fluid to thermally condition the battery array.

### TECHNICAL FIELD

This disclosure relates generally to battery packs for electrified vehicles, and in particular relates to thermal exchange plates for immersion cooled battery arrays.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles.

The battery cells generate heat during charging and discharging operations. This heat must be dissipated in order to achieve a desired level of battery performance. Heat exchanger plates, sometimes referred to as “cold plates,” are often employed to dissipate the heat generated by the battery cells.

### SUMMARY

In some aspects, the techniques described herein relate to a battery pack, including: a battery array including a plurality of battery cells, wherein the plurality of battery cells includes a first battery cell and a second battery cell; and a thermal exchange plate, wherein the first battery cell is spaced-apart from the second battery cell by the thermal exchange plate, wherein the thermal exchange plate includes a main section and a projection extending outward from the main section, wherein the projection includes a channel configured to communicate a fluid to thermally condition the battery array.

In some aspects, the techniques described herein relate to a battery pack, wherein: the thermal exchange plate includes a first face and a second face opposite the first face, the projection includes a first portion extending outward from the first face of the thermal exchange plate, and the projection includes a second portion extending outward from the second face of the thermal exchange plate.

In some aspects, the techniques described herein relate to a battery pack, wherein: the first portion extends outward from the first face of the thermal exchange plate by a distance substantially equal to a thickness of one of the battery cells, and the second portion extends outward from the second face of the thermal exchange plate by a distance substantially equal to a thickness of one of the battery cells.

In some aspects, the techniques described herein relate to a battery pack, wherein: the first portion of the projection is adjacent a bottom or top of the first battery cell, and the second portion of the projection is adjacent a bottom or top of the second battery cell.

In some aspects, the techniques described herein relate to a battery pack, wherein: the first portion and second portion of the projection are adjacent one of the bottom and the top of the first and second battery cells, and the battery pack includes voids adjacent the other of the bottom and the top of the first and second battery cells.

In some aspects, the techniques described herein relate to a battery pack, wherein: the projection is a first projection and is adjacent a bottom of the first and second battery cells, the thermal exchange plate includes a second projection including a channel configured to communicate a fluid to thermally condition the battery array, the second projection includes a first portion extending outward from the first face of the thermal exchange plate and arranged adjacent a top of the first battery cell, and the second projection includes a second portion extending outward from the second face of the thermal exchange plate and arranged adjacent a top of the second battery cell.

In some aspects, the techniques described herein relate to a battery pack, wherein: the thermal exchange plate includes a first face and a second face opposite the first face, and the projection extends outward from only one of the first face and the second face of the thermal exchange plate.

In some aspects, the techniques described herein relate to a battery pack, wherein the projection extends outward from the first face or second face a distance substantially equal to a thickness of two of the battery cells.

In some aspects, the techniques described herein relate to a battery pack, wherein the projection is adjacent one of a bottom or top of two of the battery cells.

In some aspects, the techniques described herein relate to a battery pack, wherein: the battery pack includes a void adjacent the other of the bottom and the top of the two battery cells.

In some aspects, the techniques described herein relate to a battery pack, wherein: the projection is a first projection and is adjacent a bottom of the two battery cells, the thermal exchange plate includes a second projection including a channel configured to communicate a fluid to thermally condition the battery array, the second projection extends outward from only one of the first face or the second face of the thermal exchange plate, and the second projection is adjacent the top of the two battery cells.

In some aspects, the techniques described herein relate to a battery pack, wherein the main section includes at least one channel configured to communicate fluid to thermally condition the battery pack.

In some aspects, the techniques described herein relate to a battery pack, wherein the thermal exchange plate is formed using an extrusion process.

In some aspects, the techniques described herein relate to a battery pack, wherein the thermal exchange plate is made of a metallic material.

In some aspects, the techniques described herein relate to a battery pack, wherein the thermal exchange plate is made of aluminum.

In some aspects, the techniques described herein relate to a battery pack, including: an enclosure assembly including a top wall and a bottom wall; a battery array including a plurality of battery cells; and a first thermal exchange plate and a second thermal exchange plate, wherein at least two of the battery cells are arranged between the first and second thermal exchange plates, and wherein the battery array is configured such that a first void is arranged between a top of the at least two battery cells and the top wall, and such that a second void is arranged between a bottom of the at least two battery cells and the bottom wall.

In some aspects, the techniques described herein relate to a battery pack, wherein the first and second voids are configured to communicate a fluid to thermally condition the battery array.

In some aspects, the techniques described herein relate to a method, including: communicating fluid through a channel formed in a projection extending outward from a main section of a thermal exchange plate of a battery pack to thermally condition a battery array.

In some aspects, the techniques described herein relate to a method, wherein the projection extends outward from a face of the thermal exchange plate by a distance substantially equal to a thickness of a single battery cell of the battery array, and wherein the projection is adjacent a top wall or a bottom wall of one of the battery cells of the battery array.

In some aspects, the techniques described herein relate to a method, wherein the projection extends outward from a face of the thermal exchange plate by a distance substantially equal to a thickness of two battery cells of the battery array, and wherein the projection is adjacent a top wall or a bottom wall of two of the battery cells of the battery array.

### BRIEF DESCRIPTION OF THE DRAWINGS

FIG. 1 schematically illustrates an example powertrain of an electrified vehicle.

FIG. 2 is a perspective view of an example battery pack.

FIG. 3 is a perspective view of an example battery cell.

FIG. 4 is a perspective view of a first type of thermal exchange plate.

FIG. 5 is a side view of a portion of the battery pack and illustrates an exemplary arrangement of the battery cells relative to the first type of thermal exchange plate.

FIG. 6 is a side view of a portion of the battery pack and illustrates an exemplary arrangement of the battery cells relative to a second type of thermal exchange plate.

FIG. 7 is a side view of a portion of the battery pack and illustrates an exemplary arrangement of the battery cells relative to a third type of thermal exchange plate.

FIG. 8 is a side view of a portion of the battery pack and illustrates an exemplary arrangement of the battery cells relative to a fourth type of thermal exchange plate.

FIG. 9 is a side view of a portion of the battery pack and illustrates an exemplary arrangement of the battery cells relative to a fifth type of thermal exchange plate.

### DETAILED DESCRIPTION

This disclosure relates generally to battery packs for electrified vehicles, and in particular relates to thermal exchange plates for immersion cooled battery arrays. Among other benefits, which will be appreciated from the below description, this disclosure evenly distributes coolant relative to the cells of a battery array, which provides uniform heat transfer amongst the cells and leads to efficient heat transfer within the battery array.

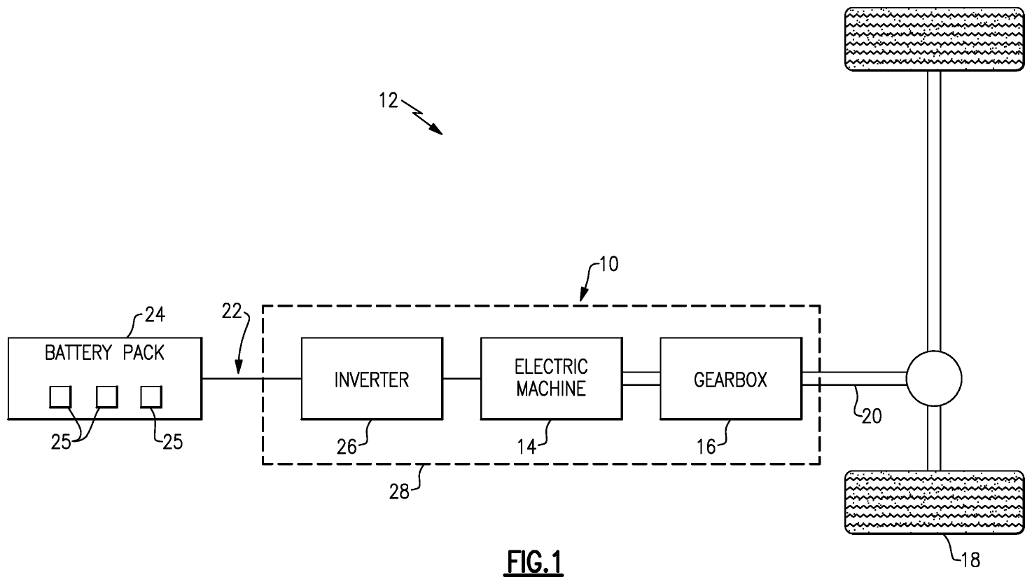

FIG. 1 schematically illustrates a powertrain 10 of an electrified vehicle 12. Although depicted as a battery electric vehicle (BEV), it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed in combination with other energy sources to propel the electrified vehicle 12.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The powertrain 10 shown in FIG. 1 is highly schematic and is not intended to limit this disclosure. Various additional components could alternatively or additionally be employed by the powertrain 10 within the scope of this disclosure.

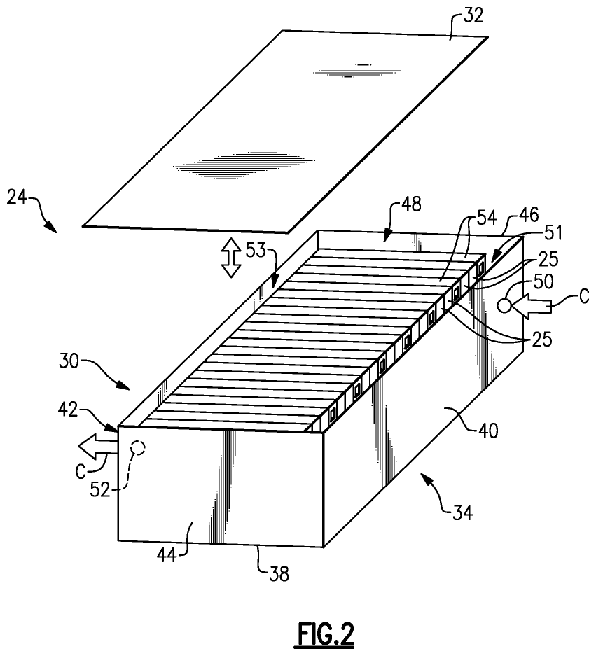

FIG. 2 illustrates additional detail of the example battery pack 24. In this example, the battery pack 24 includes an enclosure assembly 30. The enclosure assembly 30 includes a cover 32 and a tray 34. The cover 32, in this example, is vertically above the tray 34. In other examples, however, the cover 32 could be arranged below, or to a side of the tray 34. Various terms such as “above,” “below,” “top,” and “bottom” are used relative to the arrangement of the battery pack 24 in the various drawings and should not otherwise be deemed limiting.

The cover 32 is welded to the tray 34 in one example of this disclosure. While welding is mentioned, the cover 32 and tray 34 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

The cover 32 provides a top wall of the enclosure assembly 30. The tray 34 includes a bottom wall 38 opposite the cover 32, a first side wall 40, a second side wall 42 opposite the first side wall 40, a first end wall 44, and a second end wall 46 opposite the first end wall 44. The walls 38, 40, 42, 44, 46 of the tray 34 are configured to hold a battery array 48 (“array 48”).

In this example, the walls 38, 40, 42, 44, 46 of the tray 34 are each solid, fluid-tight structures. Further, the cover 32 is connected to a top of the tray 34 to provide a fluid-tight connection.

The enclosure assembly 30 includes an inlet 50, which in this example is formed in the first side wall 40, and an outlet 52, which in this example is formed in the second side wall 42. Various fluid couplings may be provided relative to the inlet 50 and outlet 52.

The battery pack 24 is configured to direct non-conductive coolant C relative to the array 48 to thermally condition the array 48, such as by absorbing heat from the array 48. The coolant C may be referred to as thermal exchange fluid. In this example, the coolant C generally flows from the inlet 50 to the outlet 52. Specifically, the coolant C generally flows from the inlet 50, into a first space 51 between the array 48 and the first side wall 40, around the battery cells 25 toward a second space 53 between an opposite side of the array 48 the second side wall 42, and to the outlet 52.

In this disclosure, the array 48 of battery cells 25 is arranged within the battery pack 24. The battery cells 25 are generally stacked face-to-face to construct the array 48. The battery pack 24 could employ any number of battery cells 25 within the scope of this disclosure. In FIG. 2, every two battery cells 25 are spaced-apart by a thermal exchange plate 54. The thermal exchange plate 54 may be considered part of the array 48.

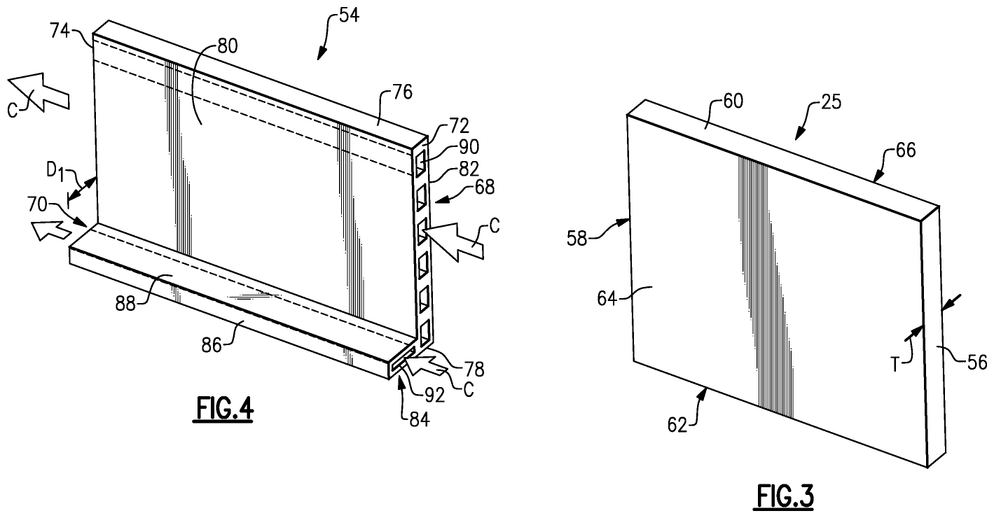

An example battery cell 25 is shown in FIG. 3. As shown, the battery cell 25 includes a first side 56 and a second side 58 opposite the first side 56. The first and second sides 56, 58 extend between a top and bottom 60, 62, respectively. Further, the battery cells 25 each include a first face 64 and a second face 66 opposite the first face 64. The first and second faces 64, 66 exhibit a greater surface area than the first and second sides 56, 58 and the top and bottom 60, 62.

In an embodiment, the battery cells 25 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

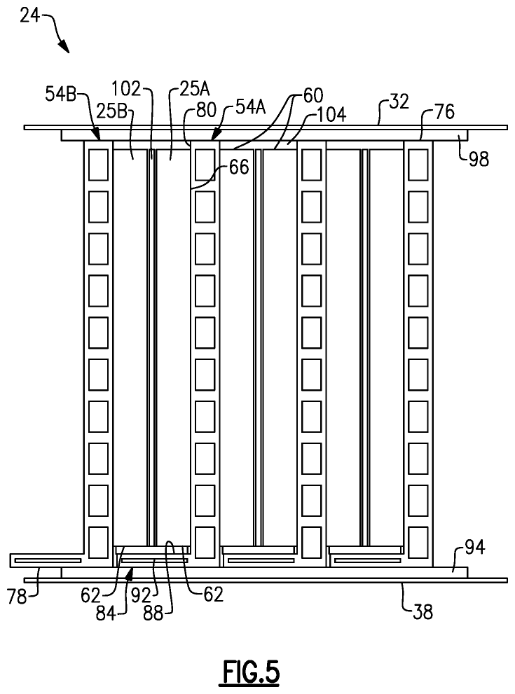

A first example thermal exchange plate 54 is shown in FIG. 4. The thermal exchange plate 54 includes a main section 68 and a projection 70. The main section 68 includes a first side 72 and a second side 74 opposite the first side 72. The first and second sides 72, 74 extend between a top 76 and a bottom 78. The main section 68 further includes a first face 80 and a second face 82 opposite the first face 80. The first and second faces 80, 82 exhibit a greater surface area than the first and second sides 72, 74 and the top and bottom 76, 78. The surface area of the first and second faces 80, 82 is slightly greater than the faces 64, 66, in this example.

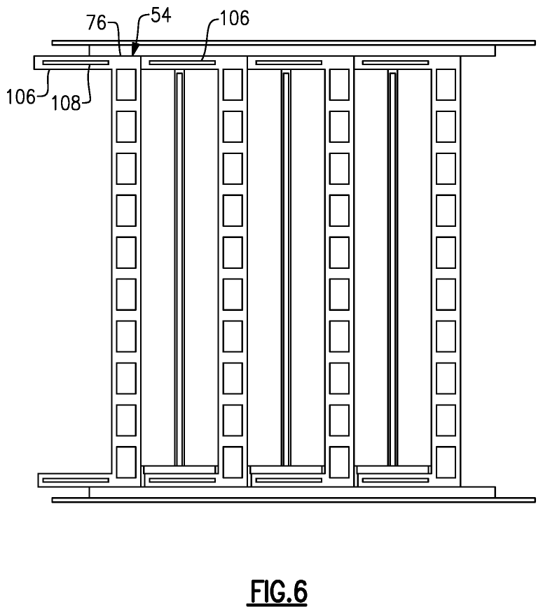

In this example, the thermal exchange plate 54 includes a projection 84 adjacent the bottom 78. The projection 84 extends outward from the first face 80. The projection 84 includes an end 86 and a top 88. The projection 84 exhibits a length extending from the first side 72 to the second side 74. The length of the projection 84 is equal to the corresponding length of the main section 68, in this example. The projection 84 exhibits a height between the bottom 78 and the top 88, in this example. The height of the projection 84 is significantly less than the corresponding height of the main section 68. The projection 84 projects a distance D₁ from the first face 80 to the end 86. The distance D₁ is substantially equal to a thickness T of two of the battery cells 25. In a particular example, the distance D₁ is greater than the thickness T of two of the battery cells 25 to account for potential cell expansion. The projection 84 is sized and shaped so as to fit above or below two of the battery cells 25, in this example, as shown in FIG. 5 and discussed below.

The thermal exchange plate 54 includes a plurality of channels configured to communicate coolant C from one side of the thermal exchange plate 54 to the other. In this example, both the main section 68 and the projection 84 each include at least one channel. A first example channel 90 is shown adjacent a top of the main section 68. The channel 90 extends through the main section 68 from first side 72 to second side 74, as represented by the dashed lines in FIG. 4. The main section 68 includes a plurality of similar channels spaced-apart vertically from one another, as shown in FIG. 4. Further, the projection 84 includes a channel 92 extending through the projection 84.

FIG. 5 is a side view of a portion of the battery pack 24, and in particular illustrates the arrangement of the battery cells 25 relative to the thermal exchange plates 54 (two are labeled as 54A, 54B in FIG. 5). With reference to two of the battery cells 25A, 25B, the battery cells 25A, 25B are arranged above the top 88 of the projection 84 of thermal exchange plate 54A. As such, coolant flowing through channel 92 can absorb heat from bottoms 62 of the battery cells 25A, 25B, which increases heat transfer between the thermal exchange plates 54 and the array 48. Further, in this example, second face 66 of cell 25A is adjacent first face 80 of the thermal exchange plate 54A, such that the thermal exchange plate 54A can absorb heat from the cell 25A. An adjacent thermal exchange plate 54B is adjacent a first face 64 of cell 25B, and absorbs heat therefrom.

As shown in FIG. 5, the bottoms 78 of the thermal exchange plates 54 are connected to the bottom wall 38 of tray 34 via an adhesive 94. Further, tops 76 are connected to the cover 32 via adhesive 96. A thermal interface material (TIM) 100 is provided between tops 88 of the projections 84 and bottoms 62 of the battery cells 25, in this example. Further, directly adjacent battery cells 25, such as battery cells 25A, 25B may be spaced-apart by cell foam 102. Further, in FIG. 5, there are voids 104 above tops 60 of the battery cells 25 and beneath the cover 32. Coolant C may flow in these voids 104 from the first space 51 to the second space 53.

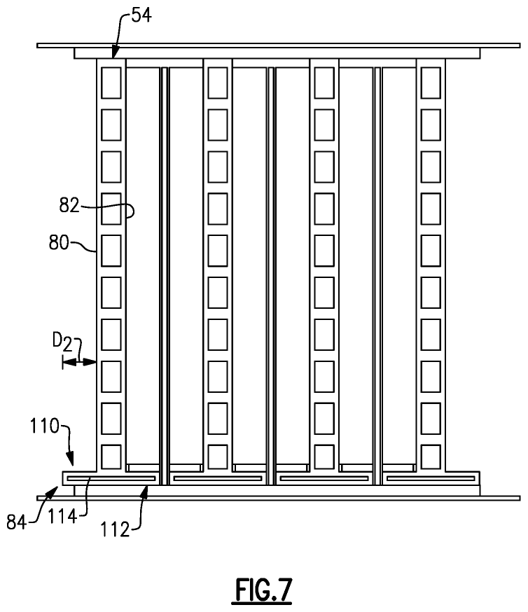

Instead of voids 104, the thermal exchange plates 54 could include an additional projection 106, which is configured substantially similar to projection 84, but is provided adjacent a top 76 of the thermal exchange plate 54 and is configured to project adjacent tops 60 of the battery cells 25, as shown in FIG. 6. Coolant C can flow through a channel 108 formed through projection 106 to absorb heat from tops 60 of the battery cells 25.

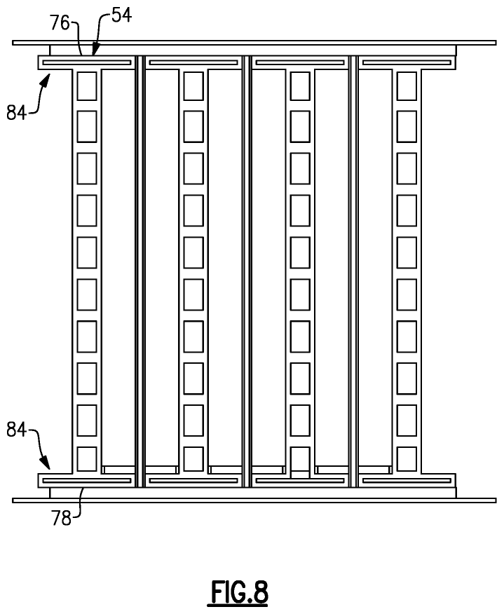

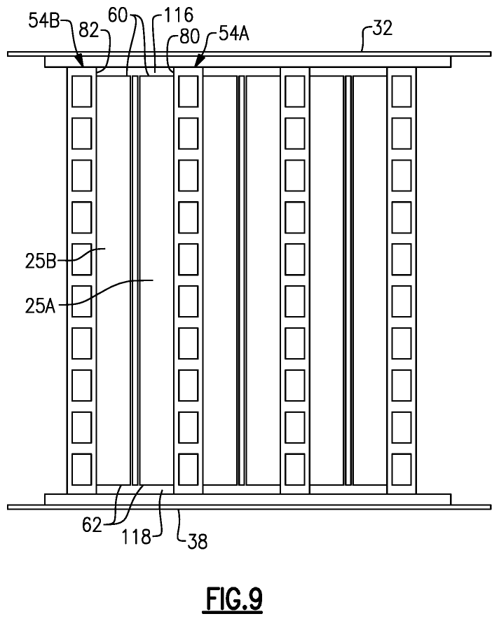

In another example, which is shown in FIG. 7, the projection 84 could include a first portion 110 that projects from first face 80 by a distance D2 and a second portion 112 that projects from second face 82 by the same distance. The distance D2 is substantially equal to the thickness T of a single battery cell 25. The projection 84 includes a channel 114 that is aligned with both the first and second portions 110, 112, in this example. In another example, the first and second portions 110, 112 may include separate channels. While in FIG. 7 the thermal exchange plates 54 only include projections 84 adjacent the bottom 78, the thermal exchange plates 54 could include similar projections adjacent the tops 76, as shown in FIG. 8.

In another example, which is shown in FIG. 9, the thermal exchange plates 54 do not include any projections, and instead only include the main section 68. In this example, the array 48 can be compressed such that there are voids 116, 118 above and below the battery cells 25. In particular, with reference to battery cells 25A, 25B, a void 116 exists between tops 60 and the cover 32. Void 116 is bound by second face 82 of thermal exchange plate 54B and first face 80 of thermal exchange plate 54A. Another void 118 exists between bottoms 62 and the bottom wall 38 of the tray 34. Void 118 is also bound by second face 82 of thermal exchange plate 54B and first face 80 of thermal exchange plate 54A. The voids 116, 118 extend substantially from the first side wall 40 to the second side wall 42. Coolant C can flow through these voids 116, 118 in addition to the channels 90 of the thermal exchange plates 54.

The above-discussed arrangements provide for uniform heat transfer amongst the battery cells 25, and in turn leads to efficient heat transfer within the array 48. It should be understood that various pumps, valves, and conduits may be present, but are not shown, to facilitate the flow of coolant C relative to the battery pack 24.

The various disclosed thermal exchange plates 54, including those with one or more projections, can be formed using an extrusion process. The thermal exchange plates 54 may be made of a metallic material, including aluminum as one example. In other examples, the thermal exchange plates 54 may be made of a thermally conductive polymer.

While various types of thermal exchange plates have been disclosed, it should be understood that the array 48 could include thermal exchange plates of different types or of a single type.

The non-conductive coolant C may be a dielectric fluid designed for immersion cooling the battery cells 25. One suitable non-conductive fluid is a Novek™ engineered fluid sold by 3M™. However, other non-conductive fluids may also be suitable, and the actual chemical make-up and design characteristics (e.g., dielectric constant, maximum breakdown strength, boiling point, etc.) may vary depending on the environment the array 48 is to be employed within. Unlike the conductive glycol utilized within known cold plate systems, the non-conductive fluid received inside the immersion cooled battery arrays of this disclosure allows for direct contact with the battery cells and other electrified components without causing electrical shorts, thereby improving cooling and performance. The exemplary immersion cooling strategies further enable high rate charging and discharging and allow for high load demands without increasing the hardware size of the battery arrays.

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a battery array including a plurality of battery cells, wherein the plurality of battery cells includes a first battery cell and a second battery cell; and
a thermal exchange plate, wherein the first battery cell is spaced-apart from the second battery cell by the thermal exchange plate, wherein the thermal exchange plate includes a main section and a projection extending outward from the main section, wherein the projection includes a channel configured to communicate a fluid to thermally condition the battery array.

2. The battery pack as recited in claim 1, wherein:
the thermal exchange plate includes a first face and a second face opposite the first face,
the projection includes a first portion extending outward from the first face of the thermal exchange plate, and
the projection includes a second portion extending outward from the second face of the thermal exchange plate.

3. The battery pack as recited in claim 2, wherein:
the first portion extends outward from the first face of the thermal exchange plate by a distance substantially equal to a thickness of one of the battery cells, and
the second portion extends outward from the second face of the thermal exchange plate by a distance substantially equal to a thickness of one of the battery cells.

4. The battery pack as recited in claim 3, wherein:
the first portion of the projection is adjacent a bottom or top of the first battery cell, and
the second portion of the projection is adjacent a bottom or top of the second battery cell.

5. The battery pack as recited in claim 4, wherein:
the first portion and second portion of the projection are adjacent one of the bottom and the top of the first and second battery cells, and
the battery pack includes voids adjacent the other of the bottom and the top of the first and second battery cells.

6. The battery pack as recited in claim 4, wherein:
the projection is a first projection and is adjacent a bottom of the first and second battery cells,
the thermal exchange plate includes a second projection including a channel configured to communicate a fluid to thermally condition the battery array,
the second projection includes a first portion extending outward from the first face of the thermal exchange plate and arranged adjacent a top of the first battery cell, and
the second projection includes a second portion extending outward from the second face of the thermal exchange plate and arranged adjacent a top of the second battery cell.

7. The battery pack as recited in claim 1, wherein:
the thermal exchange plate includes a first face and a second face opposite the first face, and
the projection extends outward from only one of the first face and the second face of the thermal exchange plate.

8. The battery pack as recited in claim 7, wherein the projection extends outward from the first face or second face a distance substantially equal to a thickness of two of the battery cells.

9. The battery pack as recited in claim 8, wherein the projection is adjacent one of a bottom or top of two of the battery cells.

10. The battery pack as recited in claim 9, wherein:
the battery pack includes a void adjacent the other of the bottom and the top of the two battery cells.

11. The battery pack as recited in claim 9, wherein:
the projection is a first projection and is adjacent a bottom of the two battery cells,
the thermal exchange plate includes a second projection including a channel configured to communicate a fluid to thermally condition the battery array,
the second projection extends outward from only one of the first face or the second face of the thermal exchange plate, and
the second projection is adjacent the top of the two battery cells.

12. The battery pack as recited in claim 1, wherein the main section includes at least one channel configured to communicate fluid to thermally condition the battery pack.

13. The battery pack as recited in claim 1, wherein the thermal exchange plate is formed using an extrusion process.

14. The battery pack as recited in claim 1, wherein the thermal exchange plate is made of a metallic material.

15. The battery pack as recited in claim 14, wherein the thermal exchange plate is made of aluminum.

16. A battery pack, comprising:
an enclosure assembly including a top wall and a bottom wall;
a battery array including a plurality of battery cells; and
a first thermal exchange plate and a second thermal exchange plate, wherein at least two of the battery cells are arranged between the first and second thermal exchange plates, and wherein the battery array is configured such that a first void is arranged between a top of the at least two battery cells and the top wall, and such that a second void is arranged between a bottom of the at least two battery cells and the bottom wall.

17. The battery pack as recited in claim 16, wherein the first and second voids are configured to communicate a fluid to thermally condition the battery array.

18. A method, comprising:
communicating fluid through a channel formed in a projection extending outward from a main section of a thermal exchange plate of a battery pack to thermally condition a battery array.

19. The method as recited in claim 18, wherein the projection extends outward from a face of the thermal exchange plate by a distance substantially equal to a thickness of a single battery cell of the battery array, and wherein the projection is adjacent a top wall or a bottom wall of one of the battery cells of the battery array.

20. The method as recited in claim 18, wherein the projection extends outward from a face of the thermal exchange plate by a distance substantially equal to a thickness of two battery cells of the battery array, and wherein the projection is adjacent a top wall or a bottom wall of two of the battery cells of the battery array.
